(19) United States
(12) Patent Application Publication
(10) Pub. No.: US 2025/0008028 A1
(43) Pub. Date: Jan. 2, 2025

(54) PLATFORM ALBUM SERVICE PROVIDING METHOD AND APPARATUS

(71) Applicant: MINIRECORD CO., LTD., Seoul (KR)

(72) Inventor: Ik KIM, Guri-si (KR)

(21) Appl. No.: 18/712,181

(22) PCT Filed: Jul. 5, 2022
(86) PCT No.: PCT/KR2022/009702

§ 371 Date: May 21, 2024

(30) Foreign Application Priority Data
Nov. 22, 2021 (KR) 10-2021-0160875
Jul. 5, 2022 (KR) 10-2022-0082534

(51) Int. Cl. H04N 1/00

(52) U.S. Cl. CPC H04N 1/00196; H04N 1/00198

(57) ABSTRACT

The present disclosure relates to a platform album service system. More specifically, the present disclosure relates to a platform album service system for providing content information corresponding to information of an identification code, which is content of a platform album, from a platform album providing service server to a user terminal as the user terminal acquires the identification code which is shown on an item.

### RELATED APPLICATIONS

This is a 371 national phase application, which claims priority to PCT Application No. PCT/KR2022/009702 file Jul. 5, 2022, titled “Platform Album Service Providing Method and Apparatus,’ which claims priority to Korean Application Nos. 10-2021-0160875 filed Nov. 22, 2021 and 10-2022-0082534 filed Jul. 5, 2022, the entireties of which are incorporated hereby by reference.

### TECHNICAL FIELD

The present disclosure relates to a platform album service providing method and apparatus therefor, which relates to a method and an apparatus for acquiring, through a terminal, an information image such as a quick response (QR) code shown on an item purchased by a user as a real object and providing content corresponding to the information image in a sever. More specifically, the present disclosure relates to a method and an apparatus for providing not only digital music of an artist to users but also an artist image or video to a user environment associated with a platform album by providing a platform album service through an exclusive application. In addition, a platform album service for providing a variety of content with a method including at least one of a method of overlaying such a video on the user environment and outputting an augmented reality image and a method of positioning content around a user avatar in a three-dimensional space and outputting the content may be provided.

### BACKGROUND ART

A number of compact disc (CD) sales on Korean K-pop surpasses fifty million as of 2021.

A market greatly grows every year as a K-pop idol album is released in a form of a celebration product (or merchandise) including a photographic card and a coupon for a fan meeting.

Experts has analyzed that such a trend is because COVID-19 has limited available content for existing K-pop fans and accordingly turns consumption of the K-pop fans to a collectible album.

In contrast, CD sales in the United States is steadily decreased as a market is reorganized to be oriented to a digital music. The experts has also analyzed that industry is rapidly declining because usage of purchasing a physical CD is limited unlike that of K-pop in Korea.

K-pop artists are referred to as last contributors that support a CD market in the United States.

Thus, an album platform that may provide various services associated with music and is accessible through an electronic device, created content connected with the album platform and providing a unique space to a determined accessing person, performance content created for a user of the album platform to access a uploaded or linked file, a service providing server for allowing various music-associated services to be provided through the album platform, and content that may interest consumers by further including a function with which a fan user accesses and uses the platform in a participative way or a function of intercommunicating with an artist are required to be developed, and competitive power is required in album business.

### DISCLOSURE OF INVENTION

### Technical Goals

The present disclosure is to provide a method and an apparatus for providing a platform album service to a user through an electronic device.

Also, the present disclosure is to provide a method and an apparatus for accessing, through a terminal of a user, content identifiable in a platform album service through an information image such as a quick response (QR) code printed on a real item purchased by the user.

In addition, the present disclosure is to provide a method and an apparatus for mapping information on a real image printed on a corresponding real item to information image such as a QR code printed on a the real item which is purchased by a user, identifying the information image through a terminal, and receiving an image corresponding to the real image in a platform album service provided through the terminal.

Furthermore, the present disclosure is to provide a method and an apparatus for counting, through inclusion of at least one of artist information corresponding to information image such as a QR code printed on a real item purchased by a user, content information, and identification information for identifying each piece of the information image and based on the identification information, how many platform albums corresponding to a real item are sold and providing content of a corresponding artist to a terminal of the user.

Also, the present disclosure is to provide a method and an apparatus for implementing a platform album service for providing not only a player for digital music of an artist but also a variety of content including a function of overlaying an artist video on a user environment and outputting an augmented reality image and a function of positioning content around a user avatar in a three-dimensional space and outputting the content.

Goals of the present disclosure are not limited to the above-mentioned goals, and goals other than the above-mentioned goals may be clearly understood by those of ordinary skill in the art from the following descriptions.

### Technical Solutions

According to an aspect, there is provided A method of providing content in a user terminal, the method including acquiring an identification code shown on an item corresponding to a platform album, transmitting information included in the identification code to a platform album providing service server as the identification code is acquired, receiving content information corresponding to the information of the identification code, which is content of the platform album, from the platform album providing service server, and outputting content corresponding to the content information through an exclusive application provided in the user terminal.

The received content information may include image information corresponding to an image shown on the item together with the identification code, and the outputting of the content may include providing, in the platform album, the image information corresponding to the image which is printed on the item.

The providing of the image information may include outputting the image information corresponding to the image printed on the item as an image in album art or a photobook of the platform album.

A sales track record or a utilization track record corresponding to the platform album may be identified based on information on the identification code, which is transmitted to the platform album providing service server.

The method may further include providing, to a user, information associated with the sales track record or the utilization track record being provided to a content-associated chart.

The content information may include at least a portion of video information and sound information corresponding to the information of the identification code.

The outputting may include outputting a video corresponding to the video information as a music video, a behind-the-scenes video, or a video message in the platform album or outputting a sound corresponding to the received sound information as a track sound or background music (BGM) of the platform album.

The method may further include displaying an icon for showing a purchase track record on the item based on the information of the identification code.

The method may further include receiving, from the platform album providing service server to an account of a user, allocation of a level classified as a predetermined class according to a purchase track record of the user or a track record of an activity of the user through the platform album, and receiving a graded benefit to the account of the user according to the allocated level.

The method may further include additionally recognizing an identification code shown on another item corresponding to the platform album, transmitting information included in the additional identification code to the platform album providing service server, and receiving additional content information corresponding to a combination of the information of the previously transmitted identification code and the information of the additional identification code.

According to another aspect, there is also provided a method of providing content in a platform album providing service server, the method including receiving information of an identification code shown on an item corresponding to a platform album from a user terminal, identifying content information of the platform album, which corresponds to the identification code, and providing the content information of the platform album to the user terminal.

The provided content information may include image information corresponding to an image shown on the item together with the identification code, and the image information corresponding to the image which is printed on the item may be output in the platform album in the user terminal.

The image information corresponding to the image printed on the item may be output as an image in album art or a photobook of the platform album.

The method may further include identifying a sales track record or a utilization track record corresponding to the platform album based on the received information of the identification code.

The method further include transmitting the identified sales track record or the identified utilization track record to an external server for providing a music charts service.

The content information may include at least a portion of video information and sound information corresponding to the information of the identification code.

A video corresponding to the video information may be output, in the user terminal, as a music video, a behind-the-scenes video, or a video message in the platform album based on the content information, and a sound corresponding to the sound information may be output, from the user terminal, as a track sound or background music (BGM) of the platform album based on the content information.

The method may further include providing, to an account of the user terminal, an icon for showing a purchase track record on the item based on the information of the identification code.

The method may further include allocating, from the platform album providing service server to an account of a user, a level classified as a predetermined class according to a purchase track record of the user or a track record of an activity of the user through the platform album, and providing a graded benefit to the account of the user according to the allocated level.

The method may further include additionally receiving information of an identification code shown on another item corresponding to the platform album from the user terminal, identifying additional content information of the platform album, which corresponds to a combination of the previously received identification code and the additional identification code, and providing the additional content information to the user terminal.

According to still another aspect, there is also provided a user terminal including an input/output interface, a memory in which an instruction is stored, and a processor, and the processor is connected to the input/output interface and the memory and configured to acquire an identification code shown on an item corresponding to a platform album, transmit information included in the identification code to a platform album providing service server as the identification code is acquired, receive content information corresponding to the information of the identification code, which is content of the platform album, from the platform album providing service server, and output content corresponding to the content information through an exclusive application provided in the user terminal.

According to still another aspect, there is also provided a platform album providing service server including a transceiver, a memory in which an instruction is stored, and a processor, and the processor is connected to the transceiver and the memory and configured to receive information of an identification code shown on an item corresponding to a platform album from a user terminal, identify content information of the platform album, which corresponds to the identification code, and provide the content information of the platform album to the user terminal.

According to still another aspect, there is also provided an item corresponding to a platform album and including a plurality of surfaces, the item including an identification code shown on at least one surface among the plurality of surfaces, and an image printed on at least one surface among the plurality of surfaces, and when the identification code is recognized by a user terminal, and when information of the identification code is transmitted to a platform album providing service server, content information including image information corresponding to the image is provided from the platform album providing service server to the user terminal.

At least a portion of a title of the platform album, a name of a production company of the platform album, a name of a distribution company of the platform album, and a copyright mark for the item may be shown on at least one surface of the plurality of surfaces.

According to still another aspect, there may be also provided a computer-readable recording medium including a program for performing the method of the present disclosure.

Details of other example embodiments are included in the following detailed description and the accompanying drawings

### Effects

A platform album service system according to an example embodiment of the present disclosure may provide artist content to a user based on augmented reality technology and virtual reality technology. Through this, fans may have a sense of closeness and a sense of immersion.

In addition, according to the platform album service system according to an example embodiment, content associated with an artist may be produced as a platform album. Through this, a production cost may be minimized, and the platform album may be automatically published each time a user is to purchase the platform album because inventory management and album demand prediction are not required.

Also, fan users may be divided by levels depending on purchase and activity track records in the platform album service system according to an example embodiment. Through this, a platform album business operator may create a new value with the artist content, and a fandom may be enhanced.

Effects of the present disclosure are not limited to the above-mentioned effects, and effects other than the above-mentioned effects may be clearly understood by those of ordinary skill in the art from the following descriptions.

### BRIEF DESCRIPTION OF DRAWINGS

FIG. 1 is a diagram illustrating a configuration of a platform album service system according to an example embodiment of the present disclosure.

FIG. 2 illustrates an example of an execution screen of an exclusive application for providing a platform album according to example embodiments of the present disclosure.

FIG. 3 illustrates an example of an augmented reality image output through an application execution screen based on a photographic card according to example embodiments of the present disclosure.

FIG. 4 illustrates an example of live content that permits watching only to a platform album purchaser.

FIG. 5 illustrates an example of three-dimensional lounge space content included in a platform album.

FIG. 6 illustrates an example of an icon and a benefit allocated to a user account according to a level of a fan user.

FIG. 7 is an example diagram illustrating a megaphone function provided to a fan user purchasing a platform album.

FIG. 8 illustrates an example of a chat window of a fan user and an artist.

FIG. 9 is an example diagram illustrating a process from purchase of real media to provision of a platform album.

FIGS. 10A through 10G are an example diagrams illustrating a screen of an exclusive application in which a platform album is provided.

FIG. 11 is a block diagram for describing a user terminal according to an example embodiment.

FIG. 12 is a block diagram for describing a platform album providing service server according to an example embodiment.

### MODE FOR INVENTION

Objectives and effects of the present disclosure and a technical configuration for achieving them will be apparent from the following example embodiments that will be described in more detail with reference to the accompanying drawings. In describing the present disclosure, when specific descriptions for a prior function or configuration are determined to unnecessarily obscure the gist of the present disclosure, the detailed descriptions will be omitted. Terms described below are terms defined in consideration of a configuration, a role, and a function of the present disclosure, and these terms may be replaced depending on an intention or a custom of a user or an operator or the like.

However, the present disclosure is not limited to the following example embodiments and may be implemented in various forms. The example embodiments are provided only to entirely disclose the present disclosure and let those skilled in the art to which the present disclosure belongs know the category of the present disclosure, and the present disclosure is merely defined by the category of the claims. Therefore, the definition thereof may be based on descriptions of the entire present specification.

In the entire specification, when an element is referred to as “including” another element, the element should not be understood as excluding other elements so long as there is no special conflicting description, and the element may include at least one other element.

Hereinafter, desirable example embodiments of the present disclosure will be described in more detail with reference to the drawings.

Meanwhile, each block of the block diagram and combinations of each operation of the flowchart may be performed by computer program instructions. Since these computer program instructions may be mounted on a processor of a programmable data processing equipment such as a general purpose computer, a special purpose computer, or a network computer, the instructions executed through a computer or the processor of the programmable data processing equipment may create a means to perform the functions described in each block of the block diagram or each operation of the flowchart. These computer program instructions may be stored in a computer-usable or computer-readable memory that can be directed to a computer or other programmable data processing equipment to implement functionality in a particular manner. Thus, it is also possible for the instructions stored in the computer-usable or computer-readable memory to produce an article of manufacture containing instruction means for performing the functions described in each block of the block diagram or each operation of the flowchart. The computer program instructions may also be mounted on a computer device or other programmable data processing equipment, such that a series of operation steps may be performed on the computer device or other programmable data processing equipment to create a computer-implemented process. Accordingly, the instructions for performing the processing equipment may also provide steps for performing the functions described in each block of the block diagram or each operation of the flowchart.

In addition, each block of the block diagram or each operation of the flowchart may represent a portion of a module, segment, or code that includes one or more executable instructions for executing a specified logical function(s). It should also be noted that in some alternative implementations, the functions noted in the blocks or the operations may occur out of order. For example, the two blocks or operations shown in succession may in fact be executed substantially in parallel, or the blocks or operations may sometimes be executed in the reverse order, depending on the corresponding function.

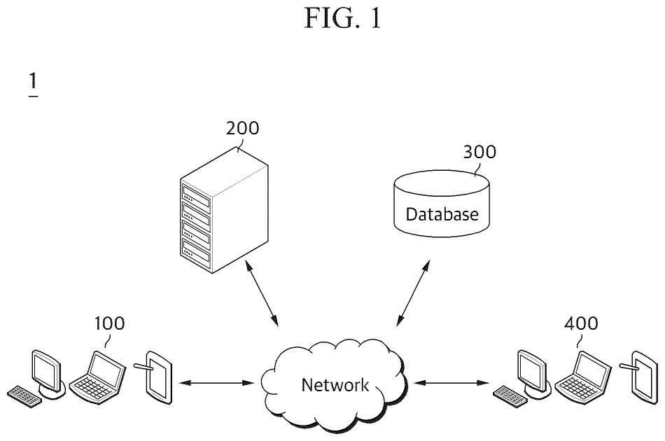

FIG. 1 is a diagram illustrating a configuration of a platform album service system according to an example embodiment of the present disclosure.

Referring to FIG. 1, a platform album service system 1 according to an example embodiment of the present disclosure may include at least one user terminal 100, a platform album providing service server 200, a database 300, and an artist terminal 400.

Here, each element is connected through a network generally. For example, as illustrated in FIG. 1, the at least one user terminal 100 may be connected to the platform album providing service server 200 through the network. Also, the platform album providing service server 200 may be connected to the at least one user terminal 100 and at least one artist terminal 400 through the network. In addition, the at least one artist terminal 400 may be connected to the platform album providing service server 200 through the network. Meanwhile, the element is not an essential element of the present disclosure, and a portion thereof may be omitted.

At this point, the network may be a connection structure for information exchange between each node such as a plurality of terminals and servers. An example of such a network may include a local area network (LAN), a wide area network (WAN), the World Wide Web (WWW), a wired or wireless data communication network, a telephone network, a wired or wireless television communication network, or the like. An example of the wireless data communication network may include 3rd generation (3G), 4th generation (4G), 5th generation (5G), 3rd generation partnership project (3GPP), 5th generation partnership project (5GPP), long-term evolution (LTE), World Interoperability for Microwave Access (WIMAX), Wireless-Fidelity (Wi-Fi), the Internet, the LAN, a wireless LAN, the WAN, a personal area network, radio frequency (RF), a Bluetooth network, a near-field communication (NFC) network, a satellite broadcasting network, an analog broadcasting network, a digital multimedia broadcasting (DMB) network, or the like, but is not limited thereto.

In the following, the term “at least one of” may be defined as including singular and plural forms. Even without the term “at least one of”, it will be apparent that each element may be single or plural and that a singular or a plural thereof may be meant. Also, whether each element is provided in singularity or plurality may depend on example embodiments.

The at least one user terminal 100 may be a terminal for purchase of and payment, by a fan having a user terminal 100, for a platform album, a photographic card, and merchandise. In addition, the user terminal 100 may identify information included in a real item purchased as such and transmit the information to the platform album providing service server 200. The service server 200 may provide content of a platform album corresponding to the information to the user terminal 100 based on the received information.

The at least one user terminal 100 may be implemented by a computer that may access a remote server or terminal through the network. Here, the computer may include, for example, a notebook computer, a desktop computer, a laptop computer, or the like that include a navigation system and a web browser. At this point, the at least one user terminal 100 may be implemented by a terminal that may access the remote server or terminal through the network. The at least one user terminal 100 may be, for example, a wireless communication device that guarantees portability and mobility and may include all handheld-based wireless communication devices such as a navigation device, a terminal based on a personal communication system (PCS), Global System for Mobile Communications (GSM), Personal Digital Cellular (PDC), Personal Handy-phone System (PHS), a personal digital assistant (PDA), International Mobile Telecommunication (IMT)-2000, Code Division Multiple Access (CDMA)-2000, W-CDMA, and the wireless broadband internet (Wibro), a smartphone, a smart pad, or the like. In addition, in example embodiments, the user terminal 100 may include an input interface for receiving an input from a user and an output interface, and an example of such interfaces may include a touch screen and a speaker. Also, the user terminal 100 may include at least one transceiver for exchanging information with a server. Furthermore, the user terminal 100 may include at least one memory for storing information. Such a user terminal 100 may be driven by control by the at least one processor.

The platform album providing service server 200 is a server for providing an application page, a program, or an application for the platform album which uses content of an artist. The platform album providing service server 200 makes the platform album based on at least one of image information, video information, and sound information generated based on an activity of the artist and provides the content which corresponds to the platform album to the user terminal 100 with which the platform album is purchased through utilization of the item. Meanwhile, in example embodiments, the platform album service server 200 may provide, to the user terminal 100, the corresponding content based on the information which is acquired from the user terminal 100.

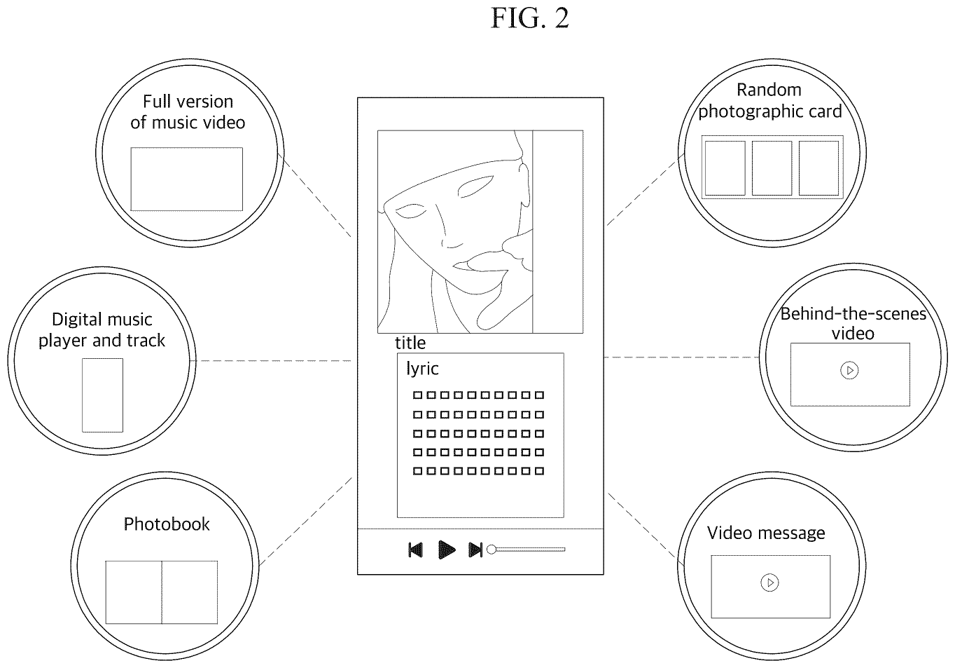

The platform album providing service server 200 may provide the platform album in a method in which the platform album is made by using an exclusive application and downloaded to be installed in the user terminal 100 with which the platform album is purchased. In this regard, a user may purchase an album of the artist in a non-face-to-face way. In other words, the platform album providing service server 200 may provide content information included in the platform album through the exclusive application provided in the user terminal 100. FIG. 2 illustrates an example of an execution screen of an exclusive application for providing a platform album according to example embodiments of the present disclosure. As illustrated in FIG. 2, text information including a title and lyrics of digital music may be displayed on the execution screen when the digital music is played. Meanwhile, in overall example embodiments, the platform album providing service server may be referred to as a sever.

According to an example embodiment, when the platform album providing service server 200 receives information of identification code (e.g., a quick response (QR) code or a serial number) from the user terminal 100, a sales track record and a utilization track record (e.g., a streaming track record of predetermined track in the platform album) corresponding to the identification code may be identified (as a first count). Subsequently, the platform album providing service serve 200 may transmit the identified sales track record and the identified utilization track record to an external server for providing a music charts service (e.g., Billboard charts, Oricon charts, Gaon charts, or the like). Through this, the sales track record or the utilization record of the platform album may be applied to a count for rankings in external music charts. When the sales track record or the utilization track record are transmitted to the external server, information on the identification code may be also provided, and the sales track record and the utilization track record may be verified. Meanwhile, when a track record on a predetermined identification code are applied to such a count for rankings, at least one of the platform album providing service server 200 and the external server may provide, to at least one of a corresponding user account and a corresponding user terminal, information indicating that a track record on utilization by people is applied. As such, the user may identify that a purchase track record or a utilization track record on an item purchased by the user is applied to rankings in music charts, and accordingly, a factor of inducing item purchase may be further increased.

Meanwhile, the identification code may be at least one of a QR code and a serial number, and the serial number may include at least one of a number and a letter. In addition, the QR code and the serial number which are shown on an identical item may have mapping relationship with each other. When the user terminal does not recognize the QR code, the user terminal may recognize the serial number, or the user may allow the user terminal to recognize the serial number. Through this, content corresponding to the serial number may be identified through the user terminal.

As illustrated in FIG. 2, as a fan user recognizes the identification code shown on the item corresponding to the platform album, (1) a music video, (2) a digital music player and a track (namely, an interface for playing each piece of digital music and a track sound in an album), (3) a photobook, (4) a digitalized photographic card, (5) a behind-the-scenes video, (6) an video message, or the like of an artist may be provided as content of the platform album in the platform album. Content information of (1) through (6) illustrated in FIG. 2 is an example of image information, sound information, and video information provided through the platform album (and corresponding to the information of the identification code). Such content may be provided in a form identifiable by the fan user through the exclusive application provided in the user terminal 100. Meanwhile, the identification code shown on the item may include identification information on corresponding content, and when the user terminal recognizes the identification code and transmits the identification code to the server, the sever may identify the content which corresponds to the identification code and provide the content so that the user terminal may access the content. In the present disclosure, the “item” is a medium through which the content of the platform album is to be provided to the user, and includes the photographic card, an album in various forms such as a long-playing record (LP), a compact disc (CD), a mini CD, or a cassette tape, merchandise, or the like. Also, in the present disclosure, when the item is an album including a storage medium, the identification code may be shown on at least a portion of the album and an article provided together with the album, and content corresponding to the album may be provided to the user terminal by identifying the identification code through the user terminal. For example, the user may allow the user terminal to recognize the identification code. Through this, the user may receive downloaded digital music corresponding to digital music included the album. As such, even in a case of an album that has difficulty in being played through the user terminal, the album may be provided together with an identification code as such, and accordingly, the user may download digital music therein from the server and easily appreciate the digital music.

In addition, a material of the photographic card which serves as the “item” is not limited to a predetermined material, and the photographic card may be made of, representatively, paper, metal, plastic, or the like.

As an example, when the user purchases an item corresponding to digital music, and when an identification code corresponding thereto is recognized by the user terminal and transmitted to the server, the server may perform a service to provide the digital music which corresponds to the identification code through the user terminal.

As another example, when the user purchase an item corresponding to a music video, and when an identification code corresponding thereto is recognized by the user terminal and transmitted to the server, the server may perform a service to provide the music video which corresponds to the identification code through the user terminal.

In association with (1) the music video, (5) the behind-the-scenes video, and (6) the video message, for example, the video information which corresponds to the information of the identification code may be provided as the music video, the behind-the-scenes video, or the video message in the platform album to the user terminal 100 through the exclusive application.

In addition, in association with (2) the digital music player and the track, for example, the sound information which corresponds to the information of the identification code may be provided as a track sound or background music (BGM) of the platform album to the user terminal 100 through the exclusive application.

Meanwhile, in association with (3) the photobook and (4) the photographic card, for example, the photobook or the photographic card may include one or more artist images transmitted to the platform album providing service server 200 or the database 300 through the artist terminal 300. Particularly, when the item which is an object of identification code recognition includes a plurality of surfaces and an image printed on at least one surface of the plurality of surfaces, the image may be also shown on the photobook or the photographic card. Meanwhile, the user may receive an experience similar to purchase of an actual album even from the platform album by allowing the image shown on the item to be shown as such in content provided through an identification code corresponding to the image, and the content shown on the platform album may be varied by purchases of various photographic cards.

Meanwhile, in example embodiments, the identification code shown on the item may include identification information corresponding to each identification code. The server may identify, by acquiring such identification information, how many items associated with the platform album are sold to customers and whether the customers has used the content corresponding to the album. Through this, sales of the platform album may be counted.

The database 300 includes a three-dimensional space database for storing a three-dimensional stage space in which the artist moves and a three-dimensional lounge space for fan users, an avatar database for storing avatar information on the fan user, and a database for storing at least a portion of the music video, the digital music player, the photobook, photographic card identification information, the behind-the-scenes video, and the video message of the artist corresponding to the content information included in the platform album (for example, made in the platform album providing service server). More specifically, the database 300 includes pieces of content information on a plurality of platform albums and mapping information that defines relationship between each of the pieces of content information and each piece of information of identification codes. Through the mapping information, the platform album service providing service server 200 may provide, based on the information of the identification code received from the user terminal 100, the content information which the user desires. Meanwhile, in example embodiments, the identification code may include unique identification information on the content, and the server may identify, based on the unique identification information on the content, content to provide to the user terminal.

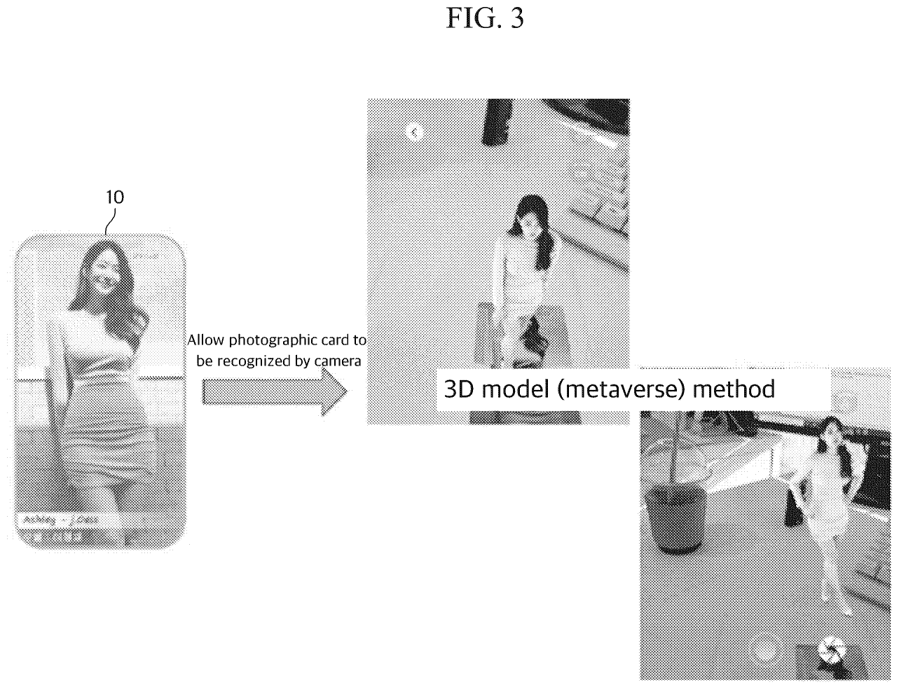

Referring to FIG. 3, an item 10 includes an identification code. When a fan user purchasing the item 10 allows the identification code to be recognized through the user terminal 100, an exclusive application may be activated, an actual image by a camera of the user terminal 100 may be overlaid with an artist image mapped to the item 10, and an augmented reality image is output through an application execution screen. That is, the platform album providing service server 200 may provide content information on a platform album by accessing the database 300 based on information of the identification code of the item 10. In other words, the platform album providing service server 200 may read out, based on the information of the identification code, the content information which is stored in the database and provide the content information to the user terminal 100. Specifically, the information of the identification code may include (1) information for identifying content such as a corresponding image, sound, video, or the like and (2) serial information for accessing the content. Through this, one identification code may be recognized by only one user terminal, and an unauthorized reproduction may be prevented. Meanwhile, in example embodiments, in a case of a photographic card showing the identification code, an image may be shown on at least one surface thereof, and the image shown on the at least one surface may be shown on the platform album which is provided to the user terminal through identification of the identification code.

As illustrated in FIG. 3, the platform album providing service server 200 may output, through the application (the exclusive application) execution screen, an image corresponding to an image (an image of a woman in FIG. 3) printed on the item 10. Meanwhile, since the augmented reality image by overlaying is one type of outputting such an image, FIG. 3 indicates that such an image may be variously provided as album art, a photobook, or the like.

As an example embodiment, when the exclusive application transmits unique identification code information of the item 10, the platform album providing service server 200 may read out content that is mapped in advance to the identification code information and stored in the database 300 and may output the content by overlaying the content on the actual image by the camera.

As another example embodiment, when the user directs the camera of the user terminal 100 to the item 10 which is registered in advance in the exclusive application, an augmented reality image of a corresponding artist is overlaid on (the actual image by the camera of) the item 10 and output. Such an image being overlaid may be implemented with a method in which the user terminal 100 acquires information shown on the item 10 or sent from the item 10, and an image of augmented reality corresponding thereto is overlaid. Meanwhile, a size of the artist may be adjusted by a user input in content shown as augmented reality, and the image corresponding to the artist may be rotated in every direction in the three-dimensional space.

As still another example embodiment, when the augmented reality image of the artist is overlaid on the actual image by the camera, through a camera interface (since the exclusive application acquires camera application permission and executes the camera, the camera interface may correspond to an interface provided by the exclusive application), a motion of the augmented reality image of the artist (e.g., the avatar) may be played, and such performance may be recorded. In other words, in addition to the augmented reality which uses the camera, an associated function for watching and recording virtual performance of the artist may be developed.

In the above-described example embodiments, a size, a rotation direction, a position for showing, or the like of the augmented reality image of the artist may be adjusted by an input from the user. Also, when the augmented reality image of the artist is output, an audio sound such as digital music or words may be played at a same time of outputting the augmented reality image or during the performance by the augmented reality image. Through this, lifelikeness and reality of the augmented reality may be increased.

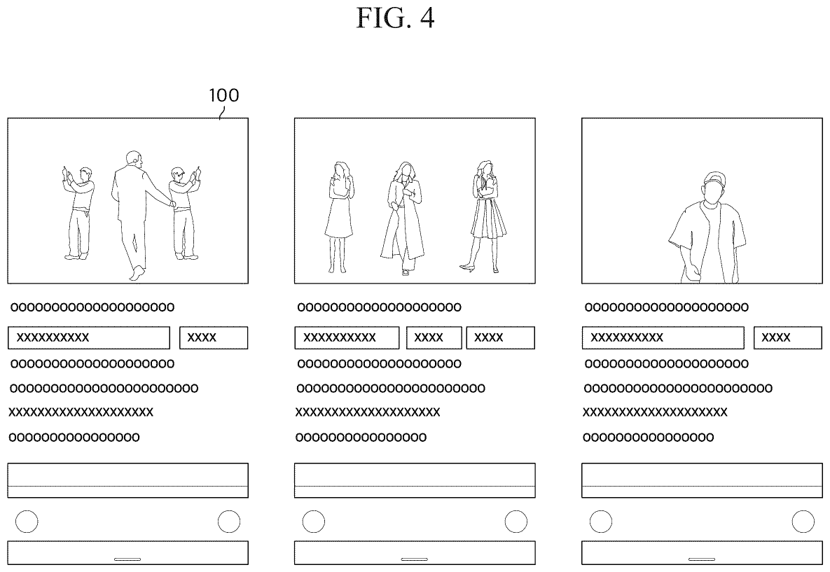

FIG. 4 illustrates an example of live content that permits watching only to a platform album purchaser.

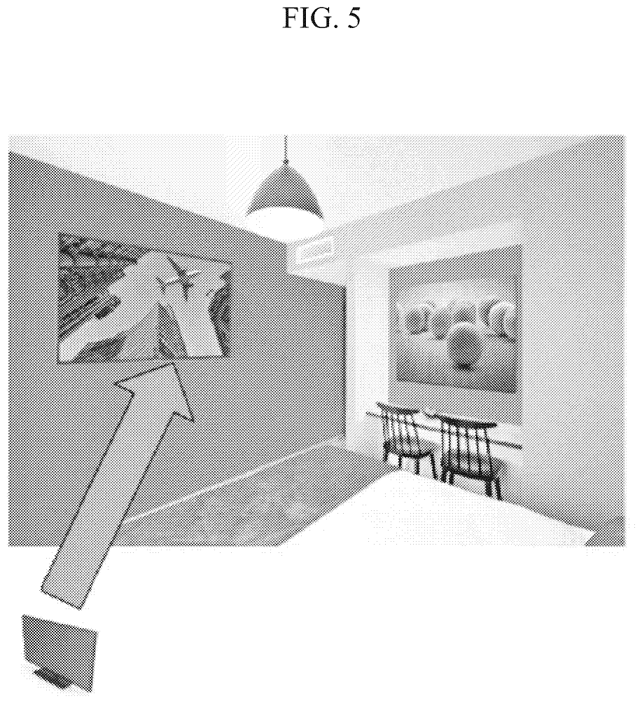

FIG. 5 illustrates an example of three-dimensional lounge space content included in a platform album. The platform album providing service server 200 provides a function with which an image or video content of an artist may be freely selected by a fan user and output through a virtual frame or television (TV) in the three-dimensional lounge space content included in the platform album.

For example, in a three-dimensional lounge space, when the fan user selects a wall-hanging TV and selects a music video, and when the user drags and drops the music video to the wall-hanging TV, the music video may be played on the wall-hanging TV. Alternatively, when the fan user selects a frame and selects the image of the artist, and when the fan user drags and drops the image of the artist to the frame, the image of the artist may be positioned in the frame.

In addition, when an avatar of the fan user enters a three-dimensional stage space, the platform album providing service server 200 may position and output at least one of a three-dimensional avatar, a video, and the image of the artist around a position of the avatar of the fan user.

Meanwhile, the platform album providing service server 200 may determine a level classified as a predetermined class according to a purchase track record or a track record of an activity of the fan user through the platform album and provide a graded benefit according to the level. Also, the platform album providing service server 200 may allocate an account of the fan user an icon corresponding to the purchase track record of the fan user, which is based on information of an identification code.

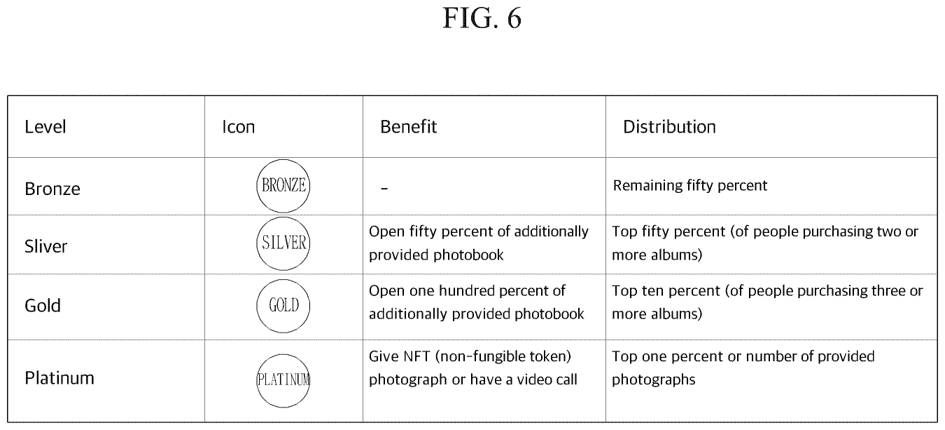

An icon in FIG. 6 may be the icon granted to the user account according to the level of the fan user. For example, respective icons of bronze, silver, gold, and platinum levels may be shown in order from a lowest ranking to a highest ranking. A benefit may be provided in a graded manner for each level granted to a user account. For example, the silver level may open fifty percent of an additionally provided photobook, the gold level may open one hundred percent of the additionally provided photobook, and the platinum level may receive a photograph of the artist to which a non-fungible token (NFT) is applied or may have a video call with the artist. An NFT photographic card may be only one original proof photograph of the artist and may be meaningful merchandise for fans.

However, the icon illustrated in FIG. 6 is an example thereof, and the icon is merely a conceptual configuration for grading according to the purchase track record or the track record of the activity of the fan user. That is, those skilled in the art may understand that a graded benefit such as allocating the user account an icon for proving the purchase track record or the track record of the activity of the user in the platform album or such as providing a unit currency usable in the platform album as a reward for the purchase track record or the track record of the activity of the user is allowed. More specifically, in example embodiments, when an identification code which is acquired through a user terminal, a server may identify that a corresponding user has purchased a real item corresponding to the identification code, and accordingly, the server may provide an icon corresponding to the purchased real item to a corresponding user account. The icon provided as such may be shown in a community activity associated with the platform album together with user information. Through this, another user may identify the purchase track record of the user in a community.

The artist terminal 400 may send a reaction of the artist to an action input from the user terminal 100 through the platform album.

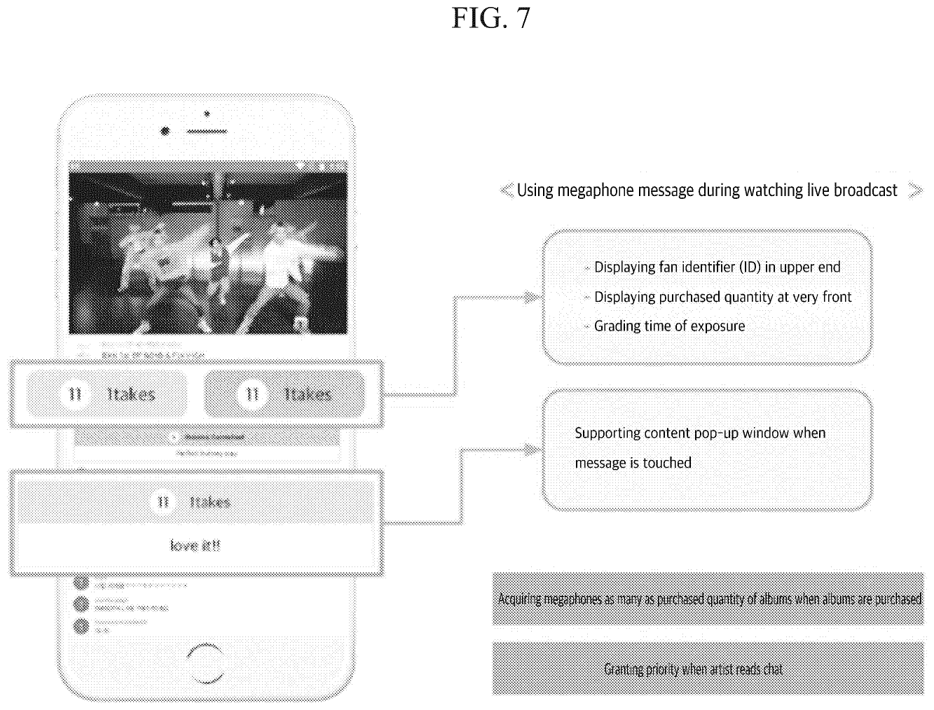

FIG. 7 is an example diagram illustrating a communication item (e.g., megaphone) function provided to a fan user purchasing a platform album. The communication item function is, as a function of sending and receiving a message to and from an artist based on a communication item, a function of mediating communication between a user terminal and an artist terminal through the communication item. As an example embodiment, a communication item message may be used during a live broadcast, a fan identifier (ID) may be displayed in an upper end as illustrated by reference numeral 11, and a quantity of purchased merchandise and a time of exposure may be displayed. When the fan user touches a message, a content pop-up window may be supported for the fan user to input a sentence to send to the artist. The communication item may be acquired in proportion to a merchandise purchase payment amount. At a time of chatting with the artist, the higher the merchandise purchase payment amount is, the higher a ranking of exposure is. Accordingly, a priority of being read may be granted.

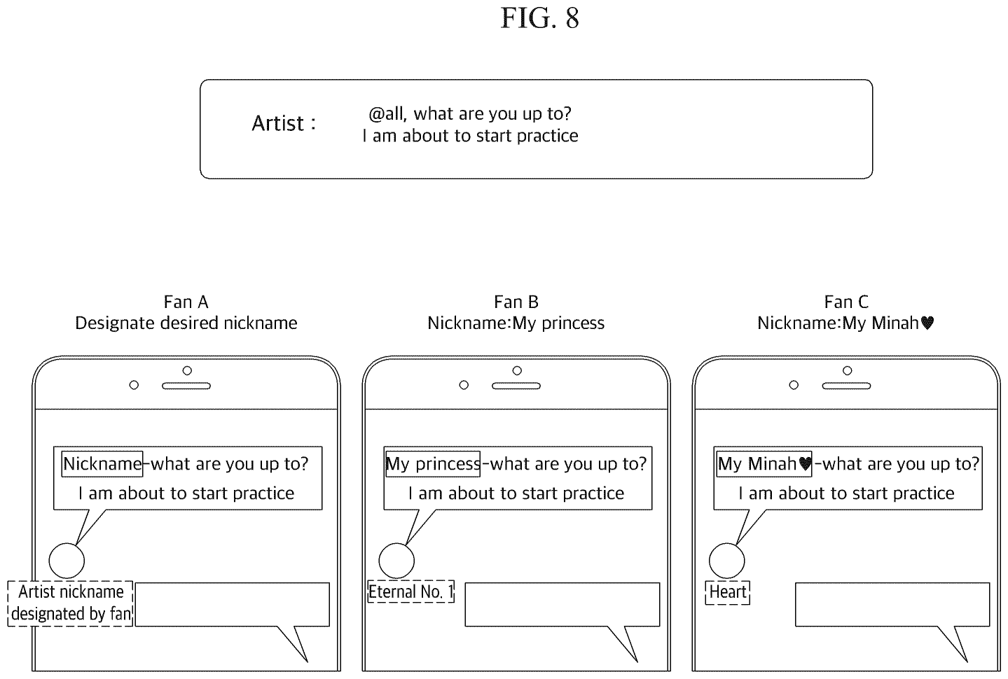

FIG. 8 illustrates an example of a chat window of a fan user and an artist. The fan user may configure nickname information that the fan user desires to be called from the artist, and the artist may use a function of talking with the fan user based on the nickname information.

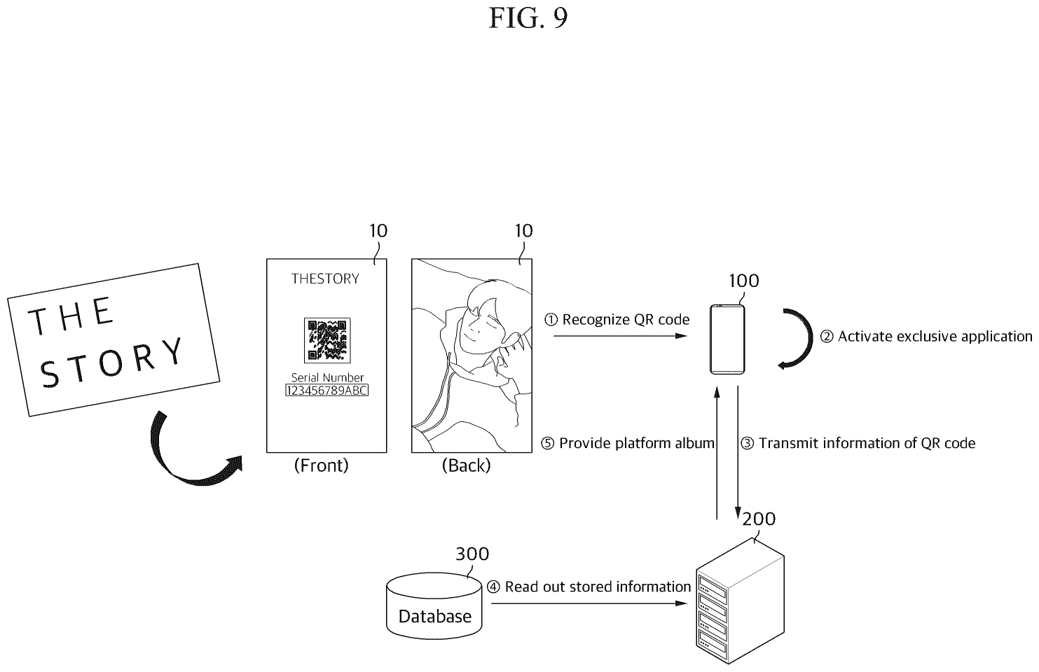

FIG. 9 is an example diagram illustrating a process from purchase of an item to provision of a platform album. Hereinafter, a method of providing the item, a composition form including an exterior of the item, or the like is merely an example, and details of the item and the platform album are not limited by details illustrated in FIG. 9.

Illustrated in a left of FIG. 9 is a real product on which a text “THE STORY” is printed. The item 10 may be enclosed in the product and sent to the user terminal 100 with which the item 10 is purchased and payment therefor is done. The item 10 illustrated in FIG. 9 is in a form of a photographic card of which an identification code is printed on a front surface and an image of an artist is printed on a back surface. However, a form of the item 10, printed information, and a position at which the information is printed are not limited thereto. Additionally, a title of the platform album, a name of a production company of the platform album, a name of a distribution company of the platform album, a copyright mark for the item, or the like in addition to the identification code may be additionally shown on one surface of the item 10.

When the user terminal 100 recognizes the identification code which is printed on the one surface of the item 10, an exclusive application provided to the user terminal may be activated. At this point, recognition of the identification code may be performed by scanning the identification code through a camera of the user terminal under an assumption that the identification code is in a form of a QR code. However, when the identification code is in a form of a serial number, since the serial number may be input through an input interface of the user terminal 100, a method of recognizing the identification code is not limited to a predetermined method. In addition, when the user terminal 100 recognizes code information printed on one surface of the item 10, the exclusive application may be activated through recognition of the code information. Meanwhile, the exclusive application may operate in a form which is driven after being downloaded and installed in the user terminal. However, the exclusive application is not limited thereto and may be activated through a cloud server or web browser without an installing process.

However, activating the exclusive application (namely, process 1) after the recognition of the identification code (namely, process 2) is merely an example, and the exclusive application may be activated in advance before the recognition of the identification code. That is, the recognition of the identification code may be a prior process for transmitting information of the identification code to the platform album providing service server 200, and it may be noted that the exclusive application may be activated before or after the recognition of the identification code.

Then, the user terminal 100 may transmit, based on a result of the recognition of the identification code, the information of the identification code to the platform album providing service server 200 through the exclusive application. The platform album providing service server 200 may receive the information of the identification code, read out content information stored in the database 300 based on the information of the identification code, and provide the content information of the platform album to the user terminal 100 based on a result thereof. For example, the platform album providing service server 200 may read out, as the content information, at least a portion of (1) image information corresponding to an image printed together with the identification code on the item 10, (2) video information corresponding to the information of the identification code, and (3) sound information corresponding to the information of the identification code and provide at least a portion of (1) the image information, (2) the video information, and (3) the sound information to the user terminal 100. The user terminal 100 may output the at least a portion of (1) the image information, (2) the video information, and (3) the sound information in a form of a music video, a behind-the-scenes video, a video message, a track sound, background music, a photographic card, a photobook, or the like.

According to an example embodiment, when the user terminal 100 recognizes each of a plurality of identification codes and transmits each identification code to the platform providing service server 200, the platform album providing service server 200 may identify an item corresponding to the each identification code, and when the number of items, a type of an item, or the like of a user account satisfies a predetermined condition, a predetermined reward may be granted to the user account. As an example, when a user collects photographic cards of an A type, a B type, and a C type, and when each identification code shown on the photographic cards is recognized and transmitted to the platform album service server 200 through the user terminal 100, the platform album providing service server 200 may verify whether the each identification code has been recognized by a terminal of another person. When the each identification code passes verification, the platform album service server 200 may determine the user account to have purchased platform albums of the A type, the B type, and the C type and accordingly grant, as the predetermined reward, a right to read special photobook content or hidden image content to the user account. As another example, when members X, Y, and Z in a unit group among members of a nine-member idol group release a platform album, and when the user collects photographic cards of the members X, Y, and Z, and when each identification code shown on the photographic cards is recognized and transmitted to the platform album providing service server 200 through the user terminal 100, the platform album providing service server 200 may verify whether the each identification code has been already recognized by a terminal of another person. When the each identification code passes verification, the platform album service server 200 may grant a right to read photobook content or hidden image content of the unit group including the member X, Y, and Z to the user account. As such, a rewarding system according to collecting a plurality of items may be established. Through this, purchase of the platform album may be promoted, and new content and fun may be provided to the user.

Meanwhile, in example embodiments, the user terminal may identify uniform resource locator (URL) information in order to transmit the recognized identification code to a server, and the URL information may be included in a QR code or configured to the user terminal The user terminal may identify a server to transmit the identification code to based on such URL information.

Also, the server may identify, based on the received identification code, whether information corresponding to the identification code is previously registered or newly registered. When the information is newly registered, a user and the identification code may be mapped, content corresponding to the identification code may be provided to the user. In addition, in a case of a previously registered identification code, mapping relationship between the identification code and the user may be identified. When the user which is mapped sends the identification code, content corresponding to the identification code may be provided to the user terminal. When the user which is not mapped sends the identification code, information indicating that the identification code has been mapped to another user may be provided to the user terminal. Through processing as such, content corresponding only to the user which purchases the item corresponding to the identification code may be provided.

Meanwhile, in example embodiments, as the identification information is recognized by the user terminal, the content may be directly played on an access screen of the application without an additional album opening procedure for playing the content. Through this, the user may further easily enjoy the content.

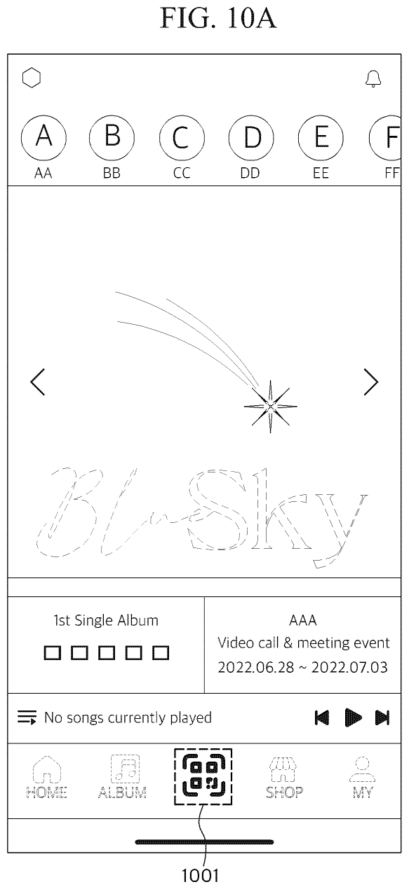

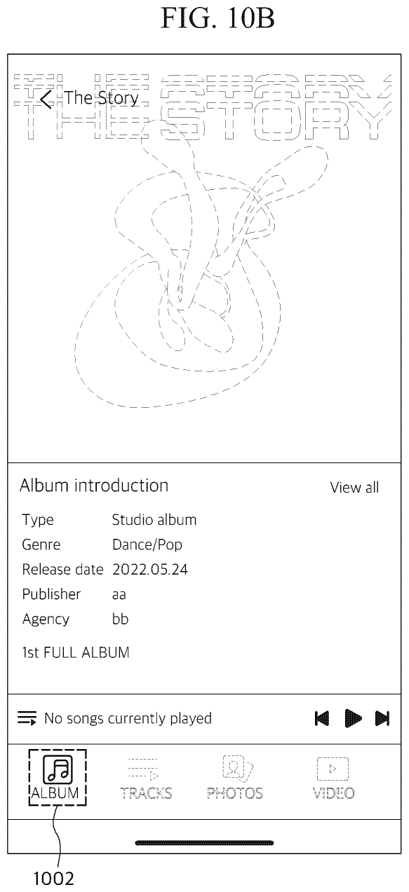

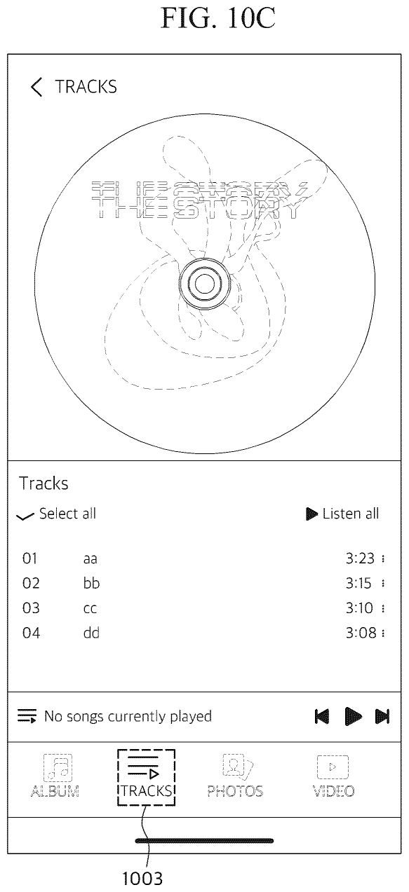

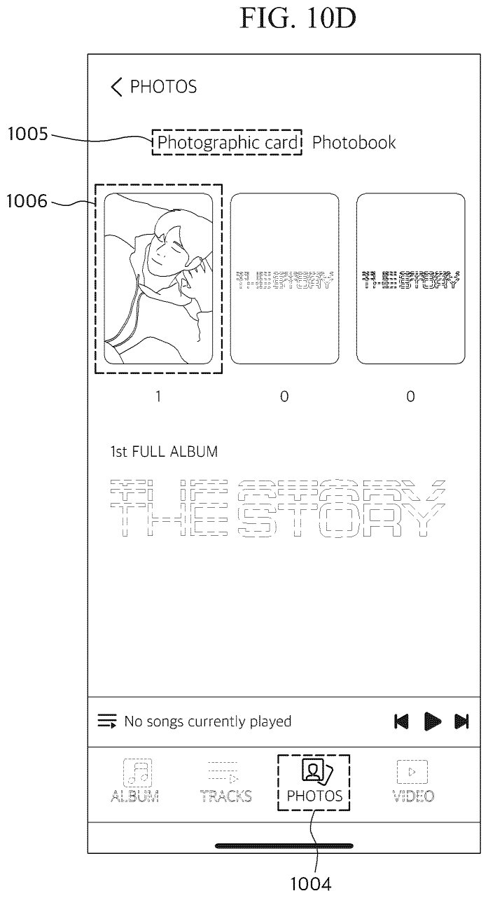

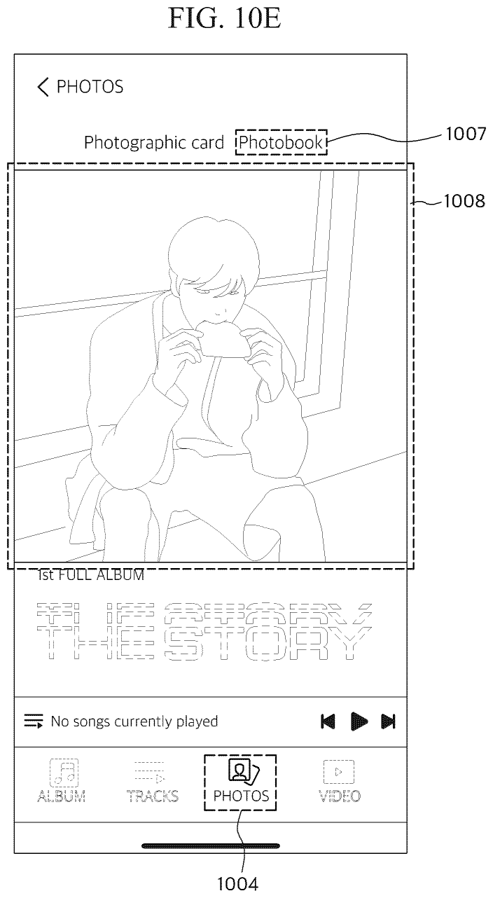

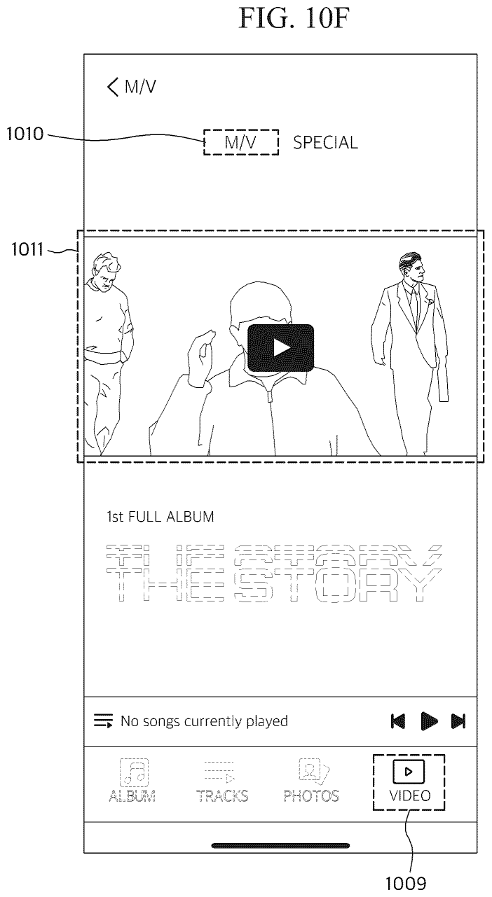

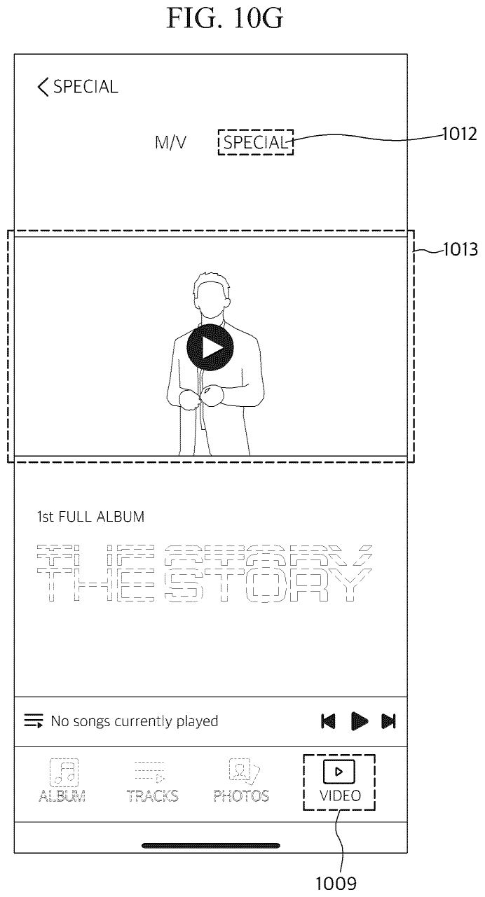

FIGS. 10A through 10G are an example diagrams illustrating a screen of an exclusive application in which a platform album is provided.

FIG. 10A is an example of a main screen of the platform album displayed in the exclusive application. A scan button 1001 for allowing the user terminal 100 to enter into a mode for recognizing an identification code may be displayed on the main screen. In addition, a “HOME” button for entering the main screen of the platform album, an “ALBUM” button for accessing album content (e.g., album information, a track digital music player, a photographic card, a photobook, a music video, a behind-the-scenes video, a video message, or the like), a “SHOP” button for moving to a purchase site/page for purchasing an item corresponding to the platform album, a “MY” button for moving to “my page”, or the like may be displayed in a lower end of the main screen. A multilingual service including Korean, English, Japanese, and Chinese may be supported for users of various nationalities throughout the exclusive application.

A list of artists (e.g., “AA”, “BB”, “CC”, or the like displayed in an upper end of FIG. 10) providing a content service in the exclusive application may be displayed on the main screen which is reached through the “HOME” button or initially displayed. When an artist displayed in the list is selected, a list of albums by the artist may be displayed on the screen, or an interface for showing preference (e.g., like) for the artist may be displayed on the screen. Meanwhile, a variety of image content of the artists may be posted in the main screen, and each piece of the image content may be displayed in sequential order to correspond to a gesture input through the user terminal 100 (for example, each piece of the image content is laterally slid to be displayed on the screen one by one according to a slide input from a user).

The purchase site/page which is reached through the “SHOP” button may support a payment service for Korean Won and other foreign currency (e.g., United State Dollar (USD) and Japanese Yen (JPY)). The payment service may be provided by using an escrow service such as PayPal, Danal, or the like. Information on an event that a user may participate in as well as a list of currently sold items may be displayed in the purchase site/page. The user may identify the information on the event in an event tab established in the purchase site/page and apply for an event of an artist that the user desires.

In the “my page” which is reached through the “MY” button, a name, a picture, a nickname, contact details, or the like allocated to a user account may be set or changed, a notification for a predetermined event may be set, a language applied to the exclusive application may be set, or a type of a currency to be used for payment may be set. In addition, a list of platform albums owned by the user account may be identified, a gift may be sent to an account of another person (e.g., a gift function), a history of gifts sent to and received from an account of another person may be identified, and an order history of the user account (e.g., delivery tracking, order cancelation, or the like) may be identified. Further, frequently asked questions occurring in utilization of the exclusive application may identified, or a one-to-one inquiry service may be used.

For example in association with the “gift function”, the user may not use identification information stored in the user account and may identify information on a recipient of a gift and information on content to be presented. Based thereon, the user may send the content to be presented through a message to the recipient of the gift. Such sending of the content may be provided through at least one method of electronic mail, a messaging application, a short messaging service (SMS), and a multimedia messaging service (MMS). A terminal of a user receiving the gift as such may transmit the identification information to a server, acquire the content which corresponds to the identification information from the server, and play the content. Meanwhile, as such, when the content corresponding to the identification information is presented from the user terminal to another user terminal with the gift function, the identification information which is stored in the user terminal from which the gift is presented may be removed, and the user receiving the gift may register the identification information and play the content corresponding to the identification information in the corresponding terminal.

FIG. 10B is an example of a screen on which the album information is displayed among screens displayed in the exclusive application as the “ALBUM” button illustrated in FIG. 10A is selected. When the “ALBUM” button is selected, a menu displayed in the lower end of the screen may be changed into an “ALBUM” button, a “TRACKS” button, a “PHOTOS” button, and a “VIDEO” button, and when the “ALBUM” button which is illustrated by reference numeral 1002 is selected, an album information page on which information on a type, a genre, a release date, a publisher, an agency, or the like is written may be displayed.

FIG. 10C is an example of a screen displayed in the exclusive application as the “TRACKS” button which is illustrated by reference numeral 1003 is selected. A track list including digital music included in an album and an interface for providing a player function for each piece of the digital music may be displayed on the screen. Specifically, the player function for each piece of the digital music may include a playing function, a lyrics displaying function, a function of downloading the digital music, a function of rotating an album CD screen illustrated when the digital music is played, or the like. In this regard, according to example embodiments, when digital music is downloaded as requested by the user, the digital music to be downloaded may be encoded and stored in a storage of the user terminal 100. Afterward, when the digital music is played through the exclusive application, the digital music may be decoded and played. At this point, an entity that encodes the digital music may be the user terminal 100 or the platform album providing service server 200, and an entity that decodes the digital music may be the user terminal 100. However, it is merely an example, and the entity that encodes/decodes the digital music may be variously set. In addition, in example embodiments, the server may perform encoding based on at least a portion of information on an identification code for the digital music and information corresponding to the user and the user terminal, and the user terminal may perform decoding based on such information. As such, a methods of the encoding and the decoding may be for each user or user terminal, and through this, only a user that purchases an item corresponding to the digital music may decode and play the digital music.

FIGS. 10D and 10E are examples of a screen displayed in the exclusive application as the “PHOTOS” button which is illustrated by reference numeral 1004 is selected. Interfaces 1005 and 1007 for selecting a form to provide an image may be provided on the screen. For example, when the interface 1005 for a form of a photographic card, photographic cards 1006 registered by a fan user to an account of the fan user may be displayed. For example, when an item is provided in the form of the photographic card with an identification code printed on a front surface and an image of an artist printed on a back surface, and when the fan user allows the user terminal 100 to recognize the identification code, the image on the back surface of the item may be displayed on the screen as illustrated FIG. 10D. A quantity of a photographic card in a digital form, which is owned by the user account, may be displayed on a lower end of each card interface (e.g., 1, 0, or 0 in FIG. 10D), and the each card interface may be flipped over according to selection by the user. Depending on example embodiments, a photographic card 1006 registered to the exclusive application may be interlocked with a video clip of the artist, and the video clip interlocked therewith may be played when the user selects the photographic card 1006. At this point, a video clip different from another may be interlocked with each of the photographic cards 1006. For example, for each image displayed in the photographic card 1006, a video clip corresponding to the each image may be interlocked. When photographic cards of three spaces illustrated in FIG. 10 are all registered (or collected), a predetermined hidden video (e.g., an unrevealed video) or hidden image (e.g., an unrevealed image) may be displayed. Meanwhile, when the interface 1007 for a form of a photobook is selected, an image 1008 of an artist corresponding to the platform album may be displayed in a changeable form (for example, laterally slid to be changed) on the screen or arranged, in a predetermined form (for example, arranged in a checkered pattern), to be displayed. In addition, each image may be displayed in a larger size or in a higher resolution depending on a choice by the user.

FIGS. 10F and 10G are examples of a screen displayed in the exclusive application as the “VIDEO” button which is illustrated by reference numeral 1009 is selected. Interfaces 1010 and 1012 for selecting a form of a provided video may be provided on the screen. For example, when the interface 1010 for a form of a music video is selected, a music video 1011 of an artist, which is provided by the artist to the platform album providing service server 200 or the database 300 through the artist terminal 400, may be displayed on the screen as illustrated by FIG. 10F. Meanwhile, when the interface 1012 for a special form is selected, a behind-the-scenes video, a video message, or the like of the artist which is provided by the artist to the platform album service server 200 or the database 300 through the artist terminal 400, other than the music video, may be displayed on the screen as illustrated by FIG. 10G. Depending on example embodiments, only a video of an artist corresponding to a photographic card owned by the user account may be provided in a viewable form in the interface 1012 for the special form. For example, when respective video messages of seven members of a seven-member idol group are provided, only a video message of a member of which a photographic card is owned by the user account may be provided in a viewable form.

However, shapes and arranged positions of the interfaces illustrated in FIGS. 10A through 10G and types of information provided in each screen are merely examples and not limited to illustrations of FIGS. 10A through 10G. Also, although not illustrated in FIGS. 10A through 10G, a button for driving a camera of the user terminal 100 in order to generate an augmented reality image may be displayed on a screen of the exclusive application. When the button is selected, the camera of the user terminal may be activated. In this case, (1) a predetermined artist image may be overlaid and displayed on an actual image by the camera to correspond to a previously recognized identification code, or (2) an image (that is an object to be provided by an augmented reality function) printed on an item may be tracked by the camera and displayed in combination with the actual image of the camera.

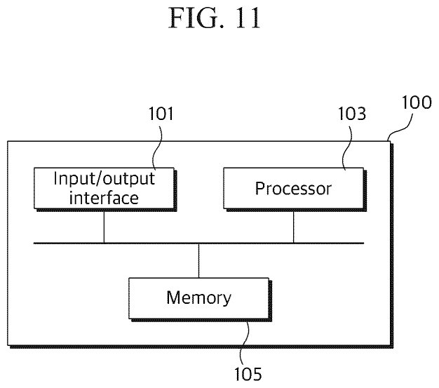

FIG. 11 is a block diagram for describing a user terminal according to an example embodiment.

According to an example embodiment, the user terminal 100 may include an input/output interface 101, a processor 103, and a memory 105. Through the input/output interface 101, the user terminal 100 may be connected with the platform album providing service server 200, the database 300, the artist terminal 400, or the like and exchange data therewith.

The processor 103 may perform the at least one method described above through FIGS. 1 through 10G in association with the user terminal 100. The memory 105 may store information for performing the at least one method described above through FIGS. 1 through 10G. The memory 105 may be a volatile or non-volatile memory.

The processor 103 may execute a program and control the user terminal 100 in order to provide information. Code of the program executed by the processor 103 may be stored in the memory 105.

The processor 103 may be connected to the input/output interface 101 and the memory 105, recognize an identification code shown on an item corresponding to a platform album, transmit information included in the identification code to the platform album providing service server as the identification code is recognized, receive content information corresponding to the information of the identification code, which is content of the platform album, and output content corresponding to the content information through an exclusive application provided in the user terminal 100.

In addition, the user terminal 100 according to an example embodiment may further include an interface for providing information to a user.

Only elements associated with the present example embodiments are illustrated in the user terminal 100 illustrated by FIG. 11. Thus, those skilled in the art associated with the present example embodiments may understand that other elements in general use may be further included in addition to the elements illustrated in FIG. 11.

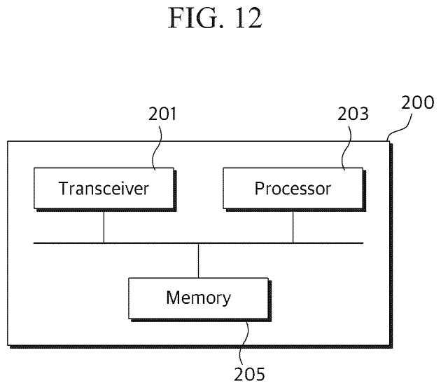

FIG. 12 is a block diagram for describing a platform album providing service server according to an example embodiment.

According to an example embodiment, the platform album providing service server 200 may include a transceiver 201, a processor 203, and a memory 205. Through the transceiver 201, the platform album providing service server 200 may be connected with the user terminal 100, the database 300, the artist terminal 400, or the like and exchange data therewith.

The processor 203 may perform the at least one method described above through FIGS. 1 through 10G in association with the platform album providing service server 200. The memory 205 may store information for performing the at least one method described above through FIGS. 1 through 10G. The memory 205 may be a volatile or non-volatile memory.

The processor 203 may execute a program and control the platform album providing service server 200 in order to provide information. Code of the program executed by the processor 203 may be stored in the memory 205.

The processor 203 may be connected to the transceiver 201 and the memory 205, receive information of an identification code shown on an item corresponding to a platform album from the user terminal 100, identify content information of the platform album, which corresponds to the identification code, and provide the content information of the platform album to the user terminal 100.

Only elements associated with the present example embodiment are illustrated in the platform album providing service server 200 illustrated by FIG. 12. Thus, those skilled in the art associated with the present example embodiment may understand that other elements in general use may be further included in addition to the elements illustrated in FIG. 12.

Fan users may be divided into levels depending on purchase and activity track records in such a platform album service system according to an example embodiment of the present disclosure. Through this, a platform album business operator may create a new value with artist content, and a fandom may be enhanced.

Also, the platform album service system according to an example embodiment of the present disclosure may provide the artist content to a user based on augmented reality technology and virtual reality technology. Through this, fans may have a sense of closeness and a sense of immersion.

In addition, according to the platform album service system according to an example embodiment, content associated with an artist may be produced as a platform album. Through this, a production cost may be minimized, and the platform album may be automatically published each time a user is to purchase the platform album because inventory management and album demand prediction are not required. Further, a fan meeting, a performance video, live performance, a video message, a behind-the-scenes video, and a photographic card as well as digital music may be provided as the artist content in the platform album.

Previously, only a profit on digital music may have been expected when a digital single has been released. However, an additional profit may be gained with a variety of content derived from the platform album according to example embodiments of the present disclosure. Also, through the platform album, new content may be constantly provided to the fans, and communication with the artist may be allowed. Through this, core fans may be managed, and a fandom may be analyzed. In other words, analysis data on nationalities/regions, genders/ages, histories of purchasing merchandise, access histories, preferred song information, time zones of activity, or the like of the fans may be drown through platform album management.

The present specification and drawings have been described with respect to the example embodiments of the present disclosure. Although specific terms are used, it is only used in a general sense to easily explain the technical content of the present disclosure and to help the understanding of the invention, and is not intended to limit the scope of the specification. It will be apparent to those skilled in the art that other modifications based on the technical spirit of the present disclosure may be implemented in addition to the embodiments disclosed herein.

1. A method of providing content in a user terminal, the method comprising:
acquiring an identification code shown on an item corresponding to a platform album;
transmitting information included in the identification code to a platform album providing service server as the identification code is acquired;
receiving content information corresponding to the information of the identification code, which is content of the platform album, from the platform album providing service server; and
outputting content corresponding to the content information through an exclusive application provided in the user terminal.

2. The method of claim 1, wherein the received content information includes image information corresponding to an image shown on the item together with the identification code, and
the outputting of the content comprises providing, in the platform album, the image information corresponding to the image which is printed on the item.

3. The method of claim 2, wherein the providing of the image information comprises outputting the image information corresponding to the image printed on the item as an image in album art or a photobook of the platform album.

4. The method of claim 1, wherein a sales track record or a utilization track record corresponding to the platform album are identified based on information on the identification code, which is transmitted to the platform album providing service server the method further comprising providing, to a user, information associated with the sales track record or the utilization track record being provided to a content-associated chart.

5. The method of claim 1, wherein the content information includes at least a portion of video information and sound information corresponding to the information of the identification code; and wherein the outputting comprises outputting a video corresponding to the video information as a music video, a behind-the-scenes video, or a video message in the platform album or outputting a sound corresponding to the received sound information as a track sound or background music (BGM) of the platform album.

6. The method of claim 1, further comprising displaying an icon for showing a purchase track record on the item based on the information of the identification code.

7. The method of claim 1, further comprising:
receiving, from the platform album providing service server to an account of a user, allocation of a level classified as a predetermined class according to a purchase track record of the user or a track record of an activity of the user through the platform album; and
receiving a graded benefit to the account of the user according to the allocated level.

8. The method of claim 1, further comprising:
additionally recognizing an identification code shown on another item corresponding to the platform album;
transmitting information included in the additional identification code to the platform album providing service server; and
receiving, from the platform album providing service server, additional content information corresponding to a combination of the information of the previously transmitted identification code and the information of the additional identification code.

9. A method of providing content in a platform album providing service server, the method comprising:
receiving information of an identification code shown on an item corresponding to a platform album from a user terminal;
identifying content information of the platform album, which corresponds to the identification code; and
providing the content information of the platform album to the user terminal.

10. The method of claim 9, wherein the provided content information includes image information corresponding to an image shown on the item together with the identification code, and
the image information corresponding to the image which is printed on the item is output in the platform album in the user terminal.

11. The method of claim 10, wherein the image information corresponding to the image printed on the item is output as an image in album art or a photobook of the platform album.

12. The method of claim 9, further comprising identifying a sales track record or a utilization track record corresponding to the platform album based on the received information of the identification code, the method further comprising transmitting the identified sales track record or the identified utilization track record to an external server for providing a music charts service.

13. The method of claim 9, wherein the content information includes at least a portion of video information and sound information corresponding to the information of the identification code; and
wherein a video corresponding to the video information is output, in the user terminal, as a music video, a behind-the-scenes video, or a video message in the platform album based on the content information, and a sound corresponding to the sound information is output, from the user terminal, as a track sound or background music (BGM) of the platform album based on the content information.

14. The method of claim 9, further comprising providing, to an account of the user terminal, an icon for showing a purchase track record on the item based on the information of the identification code.

15. The method of claim 9, further comprising:
allocating, from the platform album providing service server to an account of a user, a level classified as a predetermined class according to a purchase track record of the user or a track record of an activity of the user through the platform album; and
providing a graded benefit to the account of the user according to the allocated level.

16. The method of claim 9, further comprising:
additionally receiving information of an identification code shown on another item corresponding to the platform album from the user terminal;
identifying additional content information of the platform album, which corresponds to a combination of the previously received identification code and the additional identification code; and
providing the additional content information to the user terminal.

17. A computer-readable recording medium comprising a program for performing the method of claim 1.

18. An item corresponding to a platform album and including a plurality of surfaces, the item comprising:
an identification code shown on at least one surface among the plurality of surfaces; and
an image printed on at least one surface among the plurality of surfaces,
wherein when the identification code is recognized by a user terminal, and when information of the identification code is transmitted to a platform album providing service server, content information including image information corresponding to the image is provided from the platform album providing service server to the user terminal.

19. The item of claim 18, wherein at least a portion of a title of the platform album, a name of a production company of the platform album, a name of a distribution company of the platform album, and a copyright mark for the item is shown on at least one surface of the plurality of surfaces.
